(19) United States
(12) Patent Application Publication
(10) Pub. No.: US 2007/0277663 A1
(43) Pub. Date: Dec. 6, 2007

(54) Paper trimmer assembly

(75) Inventors: David C. Eby, Madison, WI (US); Luc Lam, Madison, WI (US); John Miller, Sun Prairie, WI (US); Gregory Falendysz, Sun Prairie, WI (US)

Correspondence Address: FOLEY & LARDNER LLP, 321 NORTH CLARK STREET, SUITE 2800, CHICAGO, IL, 60610-4764, US

(73) Assignee: Fiskars Brands, Inc.

(21) Appl. No.: 11/801,537

(22) Filed: May 10, 2007

Related U.S. Application Data
(60) Provisional application No. 60/799,636, filed on May 11, 2006.

(51) Int. Cl. B26D 1/00

(52) U.S. Cl. 83/651; 83/697

(57) ABSTRACT

A trimmer assembly for cutting a sheet or sheets of material. The trimmer assembly includes a carriage assembly that is removably connected to a base. The carriage assembly comprises a carriage and a saddle, with a blade fitting within the carriage. The carriage assembly is slidably positioned on a rail, the rail being rotatable relative to the base. A cut-line indicator, such as a print guard, is positioned between the rail and the base, and has a cut-line indicator edge for defining a cutting path of the blade.

### CROSS-REFERENCE TO RELATED APPLICATIONS

The present application claims priority to U.S. Provisional Application No. 60/799,636, filed May 11, 2006.

### FIELD OF THE INVENTION

The present invention relates generally to sheet trimmer assemblies. More particularly, the present invention relates to sheet trimmer assemblies which provide users with an indication of the cutting path of the blade.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

A variety of paper trimmer assemblies and craft trimmer assemblies are conventionally known. Several conventional assemblies generally comprise a base having a flat upper surface, along with a blade carriage which slidably moves along the flat upper surface. However, current trimmers lack an easy system for changing the blade assembly and require the user to guess as to the likely cutting path on the sheet to be cut. Current devices often include a groove or line demarcating the cutting path. However, such indicators are typically beneath any material which is to be cut, obscuring a user's view of the cutting path. Therefore, the positioning of the sheet on the base is not made with definite knowledge of the cutting path of the blade, making precise cuts difficult on current devices.

For all of these reasons, it would be desirable to develop an improved craft trimmer assembly that overcomes these shortcomings and results in a craft trimmer which is easier to use and minimizes both the risk of damage to the individual component and errors in the alignment and cutting of the materials in question.

### SUMMARY OF THE INVENTION

In one embodiment, the present invention involves a trimming assembly comprising a base having a cut-line indicator and a rail. The cut-line indicator and the rail are rotatably connected to the base. A carriage assembly is affixed to the rail to allow it to slide along the rail. The carriage assembly includes a cover and a saddle, with a blade assembly removably disposed between the cover and saddle. The saddle is slidably connected to the rail to allow the sliding action of the carriage assembly along the longitudinal axis of the rail. The blade assembly includes an outer hub having an axle protruding outward and engagable with an inner hub. A blade is positioned on the axle between the outer hub and the inner hub. The cut-line indicator includes an edge extending longitudinally across the print guard with the edge adjacent to a cutting path of the blade allowing a user to clearly observe the cutting path when the sheet to be cut is positioned on the base. In one embodiment, the cut-line indicator comprises a print guard that includes a void defined at one side by the edge and through which the blade traverses along the cutting path.

In another embodiment, the present invention involves a trimming assembly comprising a base having a print guard and a rail. The print guard and the rail are rotatably connected to the base. A carriage assembly is affixed to the rail to allow it to slide along the rail. The carriage assembly includes a cover and a saddle, with a blade assembly removably disposed between the cover and saddle. The saddle is slidably connected to the rail to allow the sliding action of the carriage assembly along the longitudinal axis of the rail. The blade assembly includes an outer hub having an axle protruding outward and engagable with an inner hub. A blade is positioned on the axle between the outer hub and the inner hub. The print guard indicator includes an edge extending longitudinally across the print guard with the edge adjacent to a cutting path of the blade allowing a user to clearly observe the cutting path when the sheet to be cut is positioned on the base. In one embodiment, the print guard that includes a void defined at one side by the edge and through which the blade traverses along the cutting path.

These and other objects, advantages and features of the invention, together with the organization and manner of operation thereof, will become apparent from the following detailed description when taken into conjunction with the accompanying drawings, wherein like elements have like numerals throughout the several drawings described below.

### BRIEF DESCRIPTION OF THE DRAWINGS

FIG. 1 is a exploded perspective view of a trimmer assembly in accordance with the principles of one embodiment the present invention;

FIG. 2 is a perspective view of the trimmer assembly of FIG. 1;

FIG. 3 is a perspective view of a trimmer assembly with the print guard and rail raised for insertion of the paper;

FIG. 4 is a perspective view of a trimmer assembly with the print guard lowered and the rail raised for alignment of the paper;

FIG. 5 is a perspective view of a trimmer assembly illustrating the blade assembly in an open position;

FIG. 6 is an illustration of the components of one embodiment of the carriage assembly;

FIG. 7 is a cross sectional view of the trimmer assembly along line A-A of FIG. 2;

FIG. 8 is an exploded view of the blade-hub assembly;

FIG. 9 is a partially exploded perspective view of a blade assembly in accordance with the principles of one embodiment of the present invention;

FIG. 10 is an exploded perspective of a rail in accordance with the principles of one embodiment of the present invention;

FIG. 11 is a cross sectional view of one embodiment of the blade carriage having a saddle lock and showing the movement of the biasing member when the cover is closed;

FIG. 12 is a cross sectional view of one embodiment of the blade carriage having a cover lock and showing the movement of the biasing member when the cover is closed;

FIGS. 13a-c are perspective view of one alternative embodiment of the blade carriage;

FIGS. 14a-b are perspective view of one alternative embodiment of the blade carriage;

FIGS. 15a-d are perspective view of one alternative embodiment of the blade carriage; and

FIG. 16 illustrates a perspective view of a trimmer assembly with the cut-line indicator lowered and the rail raised for alignment of the paper;

### DETAILED DESCRIPTION OF VARIOUS EMBODIMENTS

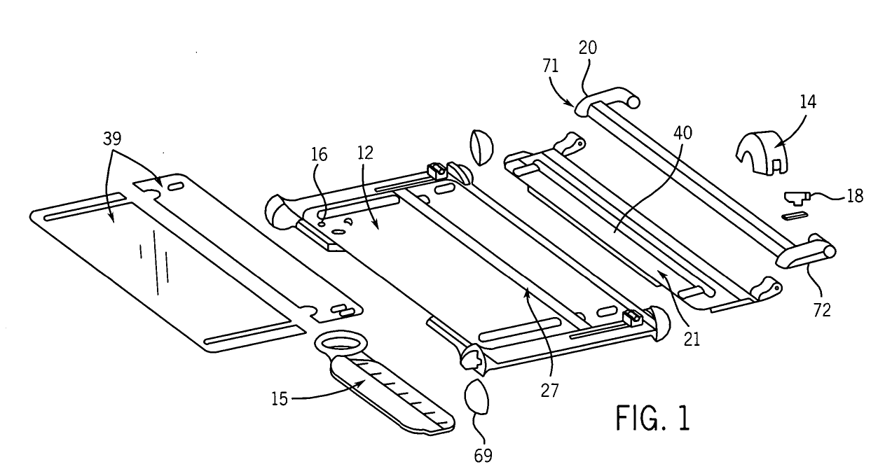

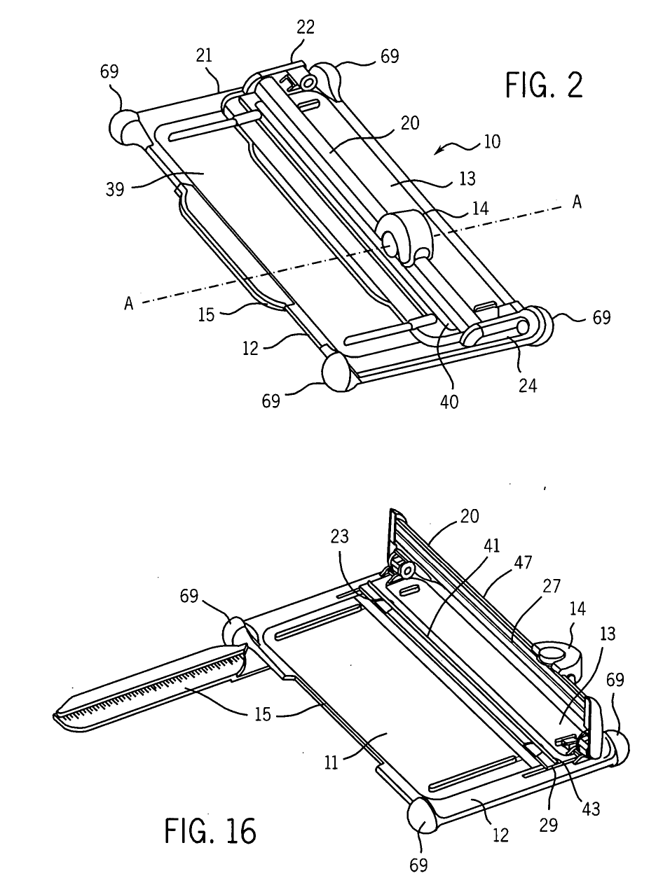

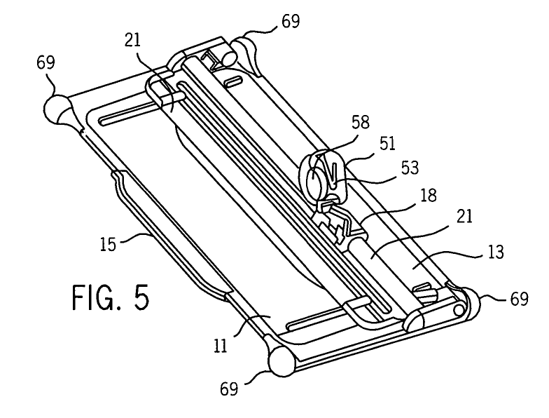

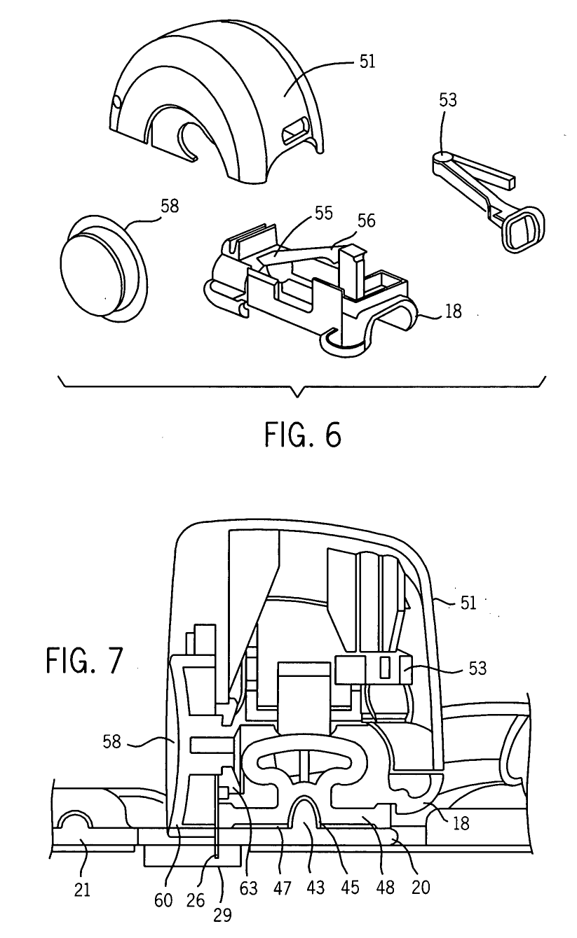

A craft trimmer assembly constructed according to one embodiment of the present invention is shown generally at 10 in FIGS. 1 and 2. The craft trimmer assembly 10 comprises a base 12, a rail 20, and a carriage assembly 14 removably attached to a rail 20. The carriage assembly 14 (shown in detail in FIGS. 6-9) comprises a cover 51 removably mounted on a saddle 18, as shown in FIG. 5. The carriage assembly 14 includes a blade 26 removably positioned on the inside thereof as part of a blade assembly 58. The saddle 18 slidably moves along the rail 20. The rail 20 is mounted on first and second hinge portions 22 and 24, respectively. A cut-line indicator 23, such as print guard 21 is positioned between the rail 20 and the base 12 and is rotatably mounted with respect to the base 12.

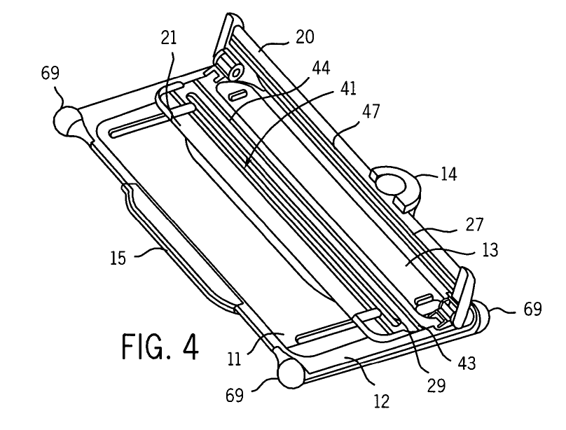

As best shown in FIGS. 4 and 16, the carriage assembly 14 is positioned within the craft trimmer assembly 10 such that the blade 26 has a cutting path 29 and, in one embodiment, aligns with a cutting surface 27 positioned within the base 12. The base 12 has an inner portion 11 and an outer portion 13. In one embodiment, a sheet 39 is placed on the base 12, such as for measurement, upon which the material to be cut rests. In one embodiment, the craft trimmer assembly 10 includes a plurality of non-skid feet 69 coupled to the base 12. In one embodiment, the base 12, includes an extension arm 15 which is extendable from the base 12 for supporting and measuring the material to be cut.

As shown in FIG. 6-9, the carriage assembly 14 comprises an assembly of separate parts. The carriage assembly 14 comprises a cover 51, a lock 53, a saddle 18, and a blade assembly 58. The cover 51 is pivotally affixed to the saddle 18 to allow the cover 51 to pivot between an open position (shown in FIG. 5) wherein the blade assembly 58 may be removed and a closed position (shown in FIG. 2) for operation of the trimmer 10. In an exemplary embodiment, the lock 53 is assembled on a cover post 52 for retaining the lock 53 with the cover 51 when the cover 51 is pivoted to an open position. In one embodiment, the lock 53 is engagable with a retention post 55 to retain the cover 51 in the closed position. When locked, the cover 51 remains able to move perpendicular to the base 12, i.e. to move downward when pressure is applied to overcome the bias of the spring 56, engaging the blade 26 to the material.

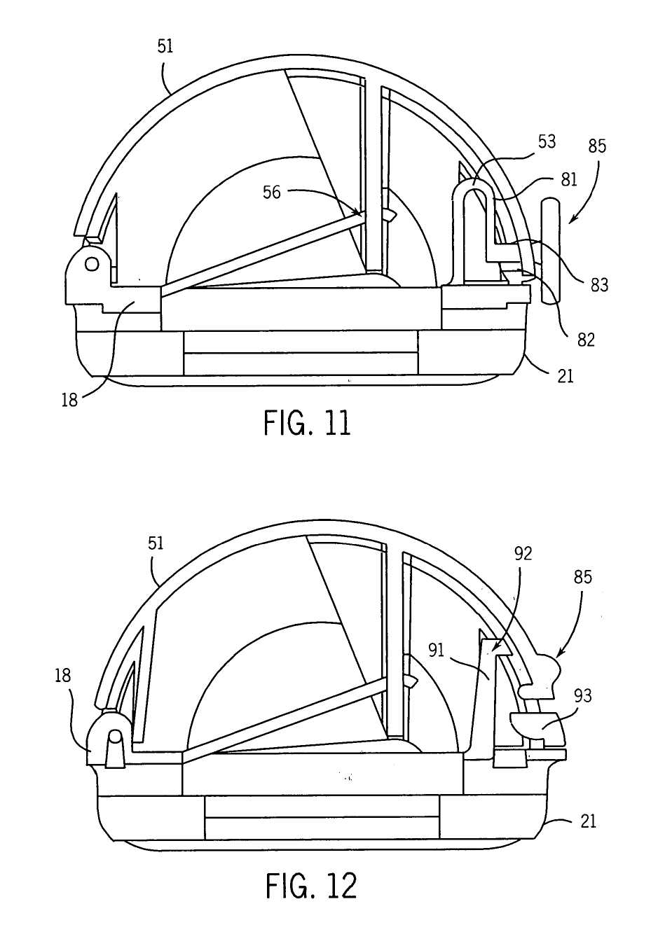

In one embodiment shown in FIG. 11, the lock 53 comprises saddle lock 81. The saddle lock 81 is a flexible member of the saddle 18, in one embodiment the lock 81 is integral to the saddle 18. The saddle lock 81 includes saddle lock tabs 82 for engaging cover tabs 83 on the cover 51. A release button 85 is provided in operative communication with the saddle lock 81, wherein actuation of the release button 85 flexes the saddle lock 81, releasing the saddle lock tabs 82 from engagement with the cover tabs 83 of the cover 51.

In one embodiment shown in FIG. 12, the lock 53 comprises a cover lock 91. The cover lock 91 is rigidly and operatively connected to the saddle 18, in one embodiment the lock 91 is integral to the saddle 18. The cover lock 91 comprises the saddle tab 82 for engaging a cover tab 83 of the cover 51. A release button 85 is provided in operative communication with the cover lock 91, wherein actuation of the release button 85 releases the saddle tab 82 from engagement with the cover tabs 83.

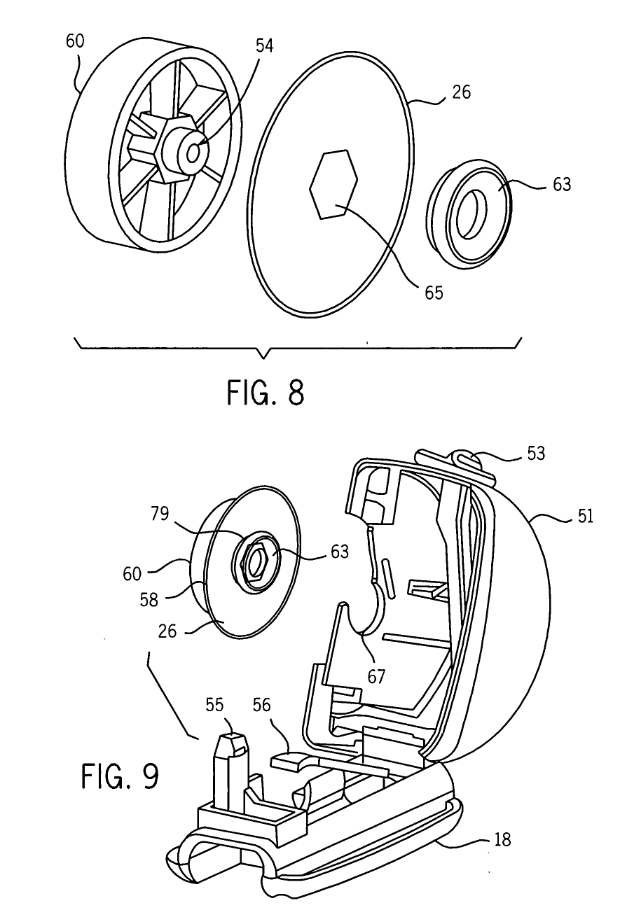

The blade assembly 58 provides for ease in changing of the blade 26. The blade assembly 58, as shown in FIG. 8, comprises an outer hub 60, an inner hub 63 and the blade 26. The outer hub 60 includes an axle 54 which passes through a center hole 65 in the blade 26 and engages the inner hub 63 for rotatably retaining the blade 26. The blade 26 can be straight, perforated, or possess virtually any other pattern. The blade 26 is pressed onto an axle 54 and becomes fixedly attached thereto such that rotation of the blade 26 will rotate the axle 54. Alternatively, the blade 26 may be positioned rotatably on the axle 54. The hole 65 is an angular hole which causes the blade 26 and the outer hub 60 and inner hub 63 to rotate as one unit. In one embodiment, a visual indicator 57 of the cover 51 indicates where the blade 26 is located within the blade assembly 58. As shown in FIG. 9, a biasing member 56, in one embodiment a leaf spring, actuates against the cover 51 and keeps the blade 26 in a protected position when no downward force is being applied to the blade assembly 58. This biasing results in the blade 26 being guarded by the rail 20, so that the blade 26 is not exposed when the rail 20 is lifted from the base 12. Application of a downward force sufficient to overcome the bias of the biasing member 56 results in the blade assembly 58 moving toward the base 12 through the void 40, contacting and cutting the material on the base 12 (shown in FIG. 7).

As shown in FIG. 9, the blade assembly 58 is removably secured in a notch 67 in the cover 51. In one embodiment, an annular recess 79 is formed between the blade 26 and the inner hub 63 for engaging the notch 67, allowing the blade assembly 58 to be rotatably fixed to the cover 51.

As shown in FIGS. 1-5, and 16 and discussed previously, the craft trimmer assembly 10 also includes the cut-line indicator 23, such as a print guard 21. The cut-line indicator 23 assists in maintaining the position of the material to be cut. A common problem with conventional trimmers is the shifting of the material to be cut, the cut-line indicator 23 reduces the probably of such shifting. In addition, the cut-line indicator 23 aids the user in keeping the material that is being cut properly aligned. The cut-line indicator 23 includes an edge 41. The edge 41 is adjacent to the cutting path of the blade, allowing a user to clearly observe the cutting path when the sheet to be cut is positioned on the base. In one embodiment the print guard 21 includes a void 40 defined on one side by the edge 41. The void 40 corresponds to the cutting path 29 of the blade 26 and is adapted to receive the blade 26 to allow the blade 26 to contact the material between the print guard 21 and the base 12.

In one embodiment, the print guard 21 includes a ridge 43. The ridge is positioned on the top side 44 of the print guard 21 (i.e. opposite the base). As shown in FIG. 7, the ridge 43 interacts with a channel 48 in the rail 20. The channel 48 is located in the bottom side 47 (i.e. that facing the base) of the rail 20 and is designed to accommodate the ridge 43. In one embodiment, the ridge 43 includes a plurality of smaller ridges 45 thereon for securing the rail 20. The ridge 43 and channel 48 interaction helps to position the blade 26 properly within the void 40, adjacent to the edge 41. In one embodiment, as shown in FIG. 7, the rib 43 includes crush ribs 45. The interaction of the channel 48 and the rib 43 and crush ribs 45 ensures the blade 26 is positioned appropriately within the void 40. The crush ribs 45 serve to stabilize the rail 20 during cutting.

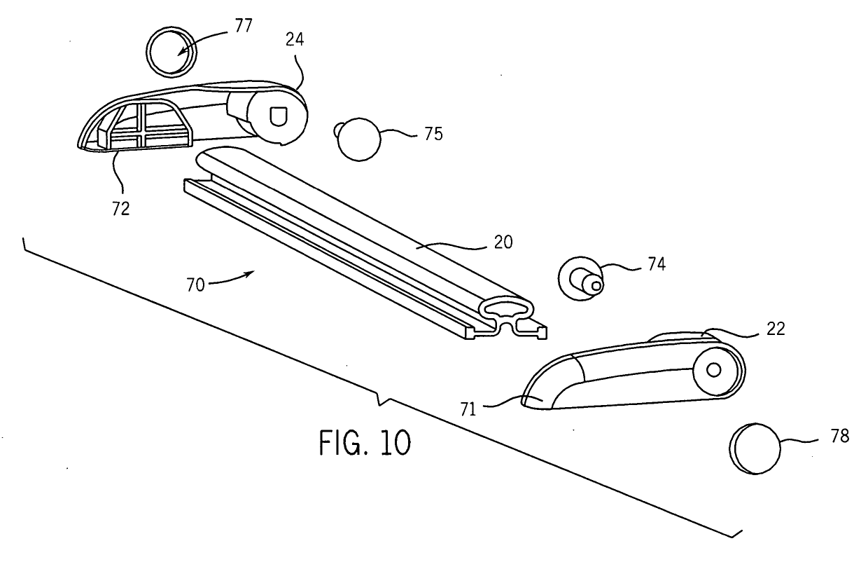

In one embodiment shown in FIG. 10, the rail 20 is part of a rail assembly 70. The rail assembly 70 includes the rail 20, a first rail arm 71 and a second rail arm 72. The rail arms 71, 72 are pivotally connectable with the base 12. In one embodiment, the rail arms 71, 72 are connected to the base via pivot pins 74, 75. In an exemplary embodiment, the rail assembly 70 includes endcaps 77, 78.

In one embodiment, the print guard 21 is rotatably affixed to the base. In one embodiment, the print guard 21 is rotatably fixed to the base at the same pivot points as the rail arms. In an exemplary embodiment, the print guard 21 pivots about the same pivot pins 74, 75 as the rail assembly 70. As such, when the print guard 21 is raised (pivoted upward, away from base) the rail assembly is rotated with it.

In one embodiment, the blade 26 is positioned at the edge 41 of the print guard 21. In one embodiment, a user is able to place a sheet on the base 12, lower the print guard 21, locate the sheet based on the edge 41 of the void 40 which indicates the cutting path 29 of the blade 26 and then lower the rail 20 and proceed to make the desired cut.

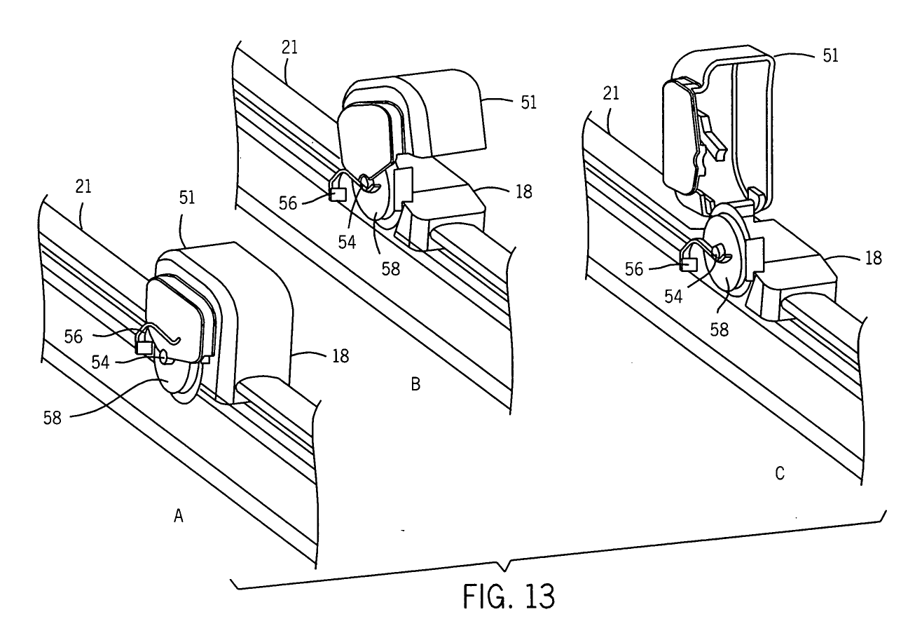

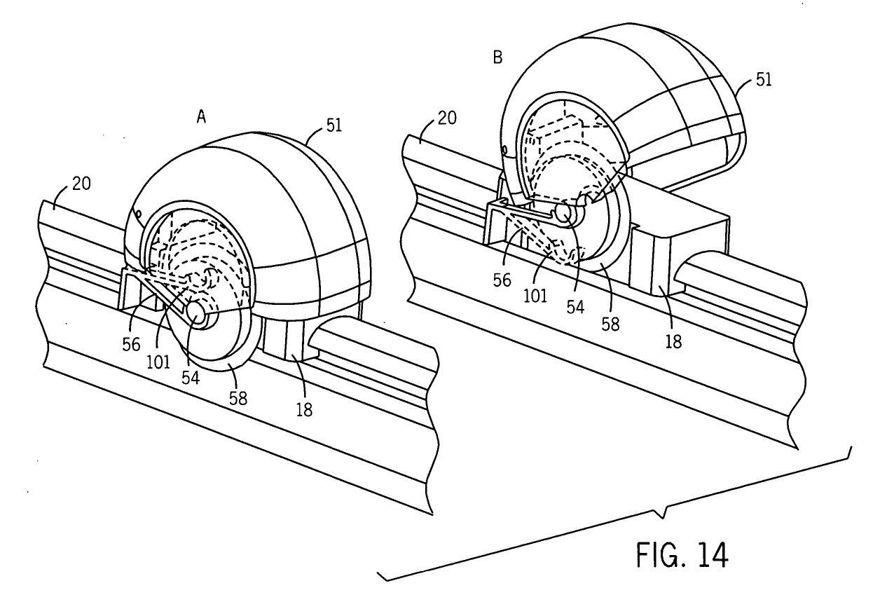

In accordance with the principles of the present invention, various carriage assemblies 14 may be used. In embodiments shown in FIGS. 13(a)-(c) and 14(a)-(b), the carriage assembly 14 includes a blade assembly 58, a cover 51, and a biasing member 56. In this embodiment, the cover 51 engages the axle 54 of blade assembly 58 and the biasing member 56 forms an arm for supporting the blade assembly 58. When a user exerts force on the cover 51, the cover 51 in turn exerts force on the axle 54 of the blade assembly 58, and when the force is sufficient to overcome the force of the biasing member 56, the blade 26 is lowered into FIGS. 14(a)-(b) illustrate an alternative embodiment of present invention, where the biasing member 56 includes a hook 101 for receiving the axle 54.

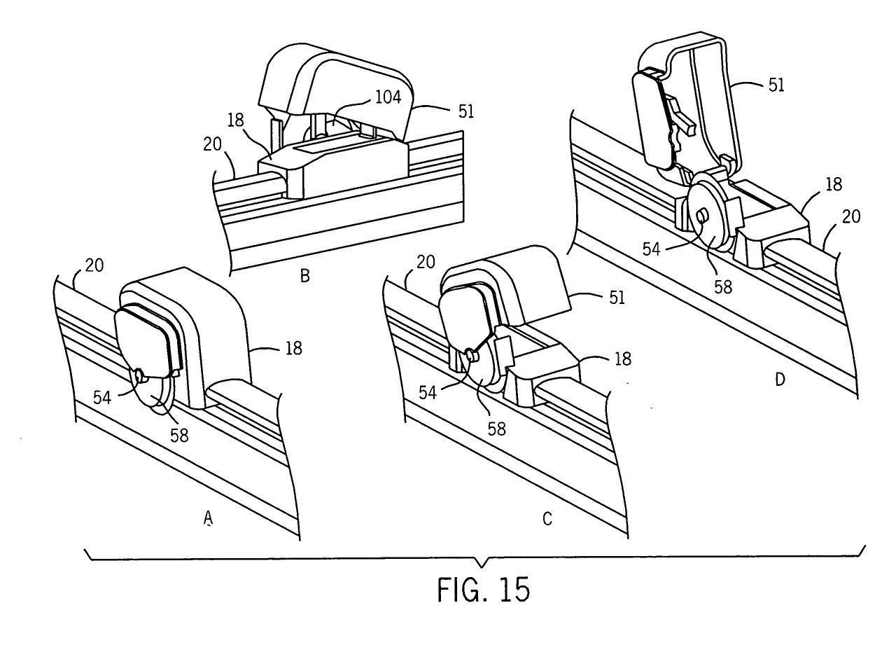

In one embodiment shown in FIGS. 15(a)-(d), the blade assembly 58 is engagable with the saddle 18. The cover 51 is clickably engagable with the blade assembly 58. The saddle 18 includes a protrusion 104 which retains the axle 54 of the blade assembly 58 (shown in FIG. 15(b)). When the cover 51 is pivoted away from the saddle 18(shown in FIGS. 15(b)-(c)), the protrusion 104 engages the axle 54 and removes the blade assembly 58 from the cover 51 (shown in FIG. 15(d)).

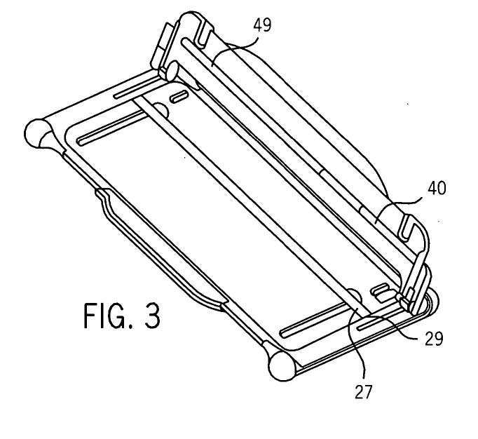

In use, shown in FIG. 3, the print guard 21 and the rail 20 are raised together by lifting the print guard 21, allowing material for being cut to be placed on the base 12. As shown in FIG. 4, once the material is inserted, the print guard 21 is lowered and the edge 41 of the void 40 clearly defines the cutting path 29. The user may then lower the rail 20 and press the cover 51 to engage the blade 26 with the material, cutting it. Movement of the carriage assembly 14 along to rail 20 creates a cut across the material.

The extension arm 15 is available for extending a measurable cut length of the trimmer assembly 10. The extension arm 15 is stowed on the underside of the base 12 when not in use (i.e. the extension arm 15 is stowed underneath the base 12). The extension arm 15 is rotatably attached to the base 12 providing the capability to pivot from a stowed position (FIG. 2) into an operating position (FIG. 16). To maintain accurate measure of cut length, it is necessary for the measuring surface of the extension arm 15 to be aligned on the same plane with the primary measuring surface of the sheet 39 positioned on the base 12. In order to achieve the same planar operating position and still be rotatably stowable underneath the base 12, a means 16 of elevating the extension arm 15 as it rotates into operating position is provided. In one embodiment, the means 16 comprise a set of inclined planes wrapped around the cylindrical post and in the arm as three ribs, sized and spaced to follow the inclined planes of the base 12.

It should be understood that the above description of the invention and the specific examples and embodiments, while indicating the preferred embodiments of the present invention, are given by demonstration and not limitation. Many changes and modifications within the scope of the present invention may therefore be made without departing from the spirit of the invention, and the invention includes all such changes and modifications.

We claim:

1. A trimmer assembly comprising:
a base;
a cut-line indicator rotatably and operatively connected to the base;
a rail rotatably and operatively connected to the base; and
a carriage assembly including a blade assembly comprising an outer hub having an axle extending therefrom and engagable with an inner hub and a blade positioned on the axle between the outer hub and the inner hub,
wherein the cut-line indicator includes an edge extending longitudinally thereacross and corresponding with a cutting path of the blade.

2. The trimmer of claim 1, wherein the cut-line indicator comprises a print guard.

3. The trimmer of claim 2, wherein the print guard includes a void defined at one side by the edge, the void defining the cutting path of the blade.

4. The trimmer of claim 1, wherein the carriage assembly further comprises a cover and a saddle slidably engaging the rail.

5. The trimmer of claim 4, wherein the blade assembly is removably disposed between the cover and the saddle and the inner hub is rotatably disposed within the cover.

6. The trimmer of claim 5, wherein the cover is pivotally coupled to the saddle.

7. The trimmer of claim 6, wherein the carriage assembly further includes a lock mechanism configured to selectively secure the cover to the saddle.

8. The trimmer of claim 7, wherein the saddle includes a plurality of saddle lock tabs each configured to engage a plurality of cover tabs of the cover.

9. The trimmer of claim 5, wherein the blade assembly is rotatably engagable with the cover.

10. The trimmer of claim 9, further comprising a biasing member positioned to actuate the cover away from the saddle.

11. The trimmer of claim 5, wherein the blade assembly is rotatably engagable with the saddle.

12. The trimmer of claim 11, wherein the saddle further comprises a biasing member rotatably engagable with the blade assembly and biasing the blade assembly away from the saddle towards the cover.

13. The trimmer of claim 1, further comprising an extension arm pivotally connected to the base, the extension arm pivotable from a position stowed below the base to a positioned extended out from the base in substantially the same plane as the base.

14. A paper trimmer comprising:
a base;
a rail rotatably and operatively connected to the base;
a carriage assembly slidably engaging the rail, the carriage assembly comprising:
a saddle slidably engaging the rail,
a cover pivotally coupled to the saddle, and
a blade disposed between the saddle and the cover; and
a cut-line indicator positioned between the rail and the base and pivotal relative to the base, the cut-line indicator having an edge proximate with the blade;
wherein the blade engages material to be cut adjacent the cut-line indicator edge.

15. The paper trimmer of claim 14, wherein the cut-line indicator comprises a print guard.

16. The paper trimmer of claim 15, wherein the print guard includes a void defined at one side by the edge, the void defining the cutting path of the blade.

17. The paper trimmer of claim 14, wherein the blade is part of a blade assembly rotatably engagable with the cover.

18. The paper trimmer of claim 17, further comprising a biasing member positioned to actuate the cover away from the saddle.

19. The paper trimmer of claim 14, wherein the blade is part of a blade assembly rotatably engagable with the saddle.

20. The paper trimmer of claim 19, wherein the saddle further comprises a biasing member rotatably engagable with the blade assembly and biasing the blade assembly away from the saddle towards the cover.

21. A trimmer assembly comprising:
a base;
a print guard rotatably and operatively connected to the base;
a rail rotatably and operatively connected to the base; and
a carriage assembly including:
a cover,
a saddle slidably engaging the rail, and
a blade assembly removably disposed between the cover and the saddle and comprising an outer hub having an axle extending therefrom and engagable with an inner hub, and a blade positioned on the axle between the outer hub and the inner hub, the inner hub rotatably disposed within the cover,
wherein the print guard has an void extending longitudinally thereacross and corresponding with a cutting path of the blade.

22. The trimmer of claim 21, wherein the saddle further comprises a biasing member rotatably engagable with the blade assembly and biasing the blade assembly away from the saddle towards the cover.

23. The trimmer of claim 21, wherein the blade assembly is rotatably engagable with the cover.

24. The trimmer of claim 21, wherein the blade assembly is rotatably engagable with the saddle.
